(19) United States
(12) Patent Application Publication
(10) Pub. No.: US 2014/0346126 A1
(43) Pub. Date: Nov. 27, 2014

(54) METHOD AND SYSTEM USING MELTING FILTER FOR SEPARATING MIXTURE

(71) Applicant: Local Independent Administrative Agency, Sapporo (JP)

(72) Inventors: Masahiro Teduka, Sapporo-shi (JP); Takeshi Nishioka, Sapporo-shi (JP); Masaharu Jo, Sapporo-shi (JP)

(73) Assignee: LOCAL INDEPENDENT ADMINISTRATIVE AGENCY, Sapporo (JP)

(21) Appl. No.: 14/328,441

(22) Filed: Jul. 10, 2014

Related U.S. Application Data
(63) Continuation-in-part of application No. 12/896,448, filed on Oct. 1, 2010.
Application No. 12/896,448 is a continuation-in-part of application No. PCT/JP2009/067452, filed on Sep. 30, 2009.
Application No. PCT/JP2009/067452 is a continuation-in-part of application No. PCT/JP2009/057042, filed on Mar. 31, 2009.

(30) Foreign Application Priority Data
Apr. 4, 2008 (JP) 2008-120011
Feb. 2, 2009 (JP) 2009-041440
Nov. 25, 2013 (JP) 2013-256447

(51) Int. Cl. B01D 9/00; B01D 17/00

(52) U.S. Cl. CPC B01D 9/0013; B01D 17/00
USPC 210/769; 210/184; 210/173

(57) ABSTRACT

The present invention provides a method and system using a melting filter medium for separating a mixture (e.g., a mixture of an aqueous solution and either or both of oil and solids immiscible in the aqueous solution) to be separated. The mixture is separated into a liquid passing through the filter layer of the filter medium and a captured material captured in the filter layer. The filter medium and the captured material are separated by melting the filter medium.

### FIELD OF THE INVENTION

The present invention relates to a method and system for separating a liquid/liquid mixture or a liquid/solid mixture.

### BACKGROUND

A method and system for separating liquid/liquid mixtures or liquid/solid mixtures includes filtration. In filtration, these mixtures are supplied to a filter medium made of a porous material (e.g., diatomaceous earth), a fibrous material, and layer of solids. In case of the liquid-solid mixtures, a liquid passes through the filter medium, solids in the liquid are captured by the filter medium (Perry et al., Perry's Chemical Engineers' Handbook, 6th ed., pp. 19.65-19.89, 1984; this hand book is referred to as the “Perry document” hereinafter). In case of the liquid-liquid mixtures, a low-viscosity liquid passes through the filter medium, while a high-viscosity liquid immiscible in the low-viscosity liquid is captured by the filter medium. With respect to the low-viscosity liquid and the high-viscosity liquid, a liquid and a liquid (hereinafter referred to as an “immiscible liquid”) immiscible therewith in a liquid-liquid mixture (a plurality of immiscible liquids may be included) are regarded as the low-viscosity liquid and the high-viscosity liquid, respectively, by a relative comparison of viscosities.

### 1. Filtration and Recovery of Captured Material

In filtration, it is generally difficult to recover a material (the solids and/or the high-viscosity liquid) from the filter medium which has captured the material or to improve a recovery rate (=recovered amount of captured material from filter medium that captured material/amount of captured material captured in filter medium). Filtration also includes separation by a membrane (e.g., an ultra filtration membrane). Methods for recovering the captured material from the filter medium include a method using an organic solvent (e.g., hexane, and acetone) (the Perry document, pp. 15.1-15.20). However, hexane and acetone solvent are an explosion hazard. Also, such method may cause deterioration of the captured material in a chemical reaction.

### 2. Melting Filter Medium

Filter crystals described below can be used in this present invention as a filter medium that forms a filter layer. The filter layer of the filter crystals makes it possible to capture a high-viscosity liquid that is immiscible in a low-viscosity liquid, or solids in a liquid. The filter crystals are the followings:

1) Fine crystals (which may be grains), needle/rod-like crystals, dendrite-like crystals, or flake/plate-like crystals produced in a liquid; crystals produced by removing or scraping crystals formed by contact between a cooled solid (such as metal) or a cooled fluid (gas and/or liquid) and a liquid; or crystals by grinding (such as impact grinding using rotation centrifugal force) or by crushing after their formation.

2) Crystals produced by mixing liquid in gas by low-temperature evaporation, heating evaporation, spraying, or liquid dropping, forming crystals by contact between the resultant mixture and a cooled solid (such as metal) or a solid (such as plastic), and removing or scraping the crystals from the cooled solid or the solid.

3) A crystal group including the crystals described in 1) and/or 2).

The filter crystals are melting single crystals and/or polycrystals. Possible substances for the filter crystals include a material such as ice. The above-mentioned 1), 2) and 3) are described in the following a) and b).

a) Formation of Filter Crystals in Liquid

It is known from documents below that filter crystals can be formed in liquid by rapid crystallization of single-component liquids, or by crystallization or rapid crystallization of multi-component liquids.

With respect to formation of ice crystals from an aqueous solution, Thijssen, H. A. C., A. Spicer ed., Applied Science Pub. LTD., London UK, pp. 117-121 1974 (hereinafter referred to as the “Thijssen document”) discloses the followings:

1. By unidirectional freezing, the ice grows in the form of needles or bars with an irregular cross section perpendicular to the cooled surface.

2. A nucleation rate (an amount of fine crystals) increases with increasing cooling rate or increasing solute concentration.

3. Crystal size increases with increasing the crystal residence time.

With respect to freezing of water, Furukawa et al., JASMA vol. 21, 217-223 2004 discloses that an the amount of dendrite crystals increases with increasing cooling rate. In addition, Hobbs, P. V., Clarendon Press Oxford, pp. 580-581 1974 discloses that dendrite crystals are easily formed from an aqueous solution as compared with pure water.

Examples of materials other than water that can be used for the filter crystals of the present invention include materials such as clathrate hydrates (U.S. Pat. No. 6,237,346 B1).

U.S. Pat. No. 3,845,230 and U.S. Pat. No. 3,320,153 disclose techniques that form ice-crystal layers from mixtures composed of mixtures to be separated and ice crystals. The U.S. Pat. No. 3,845,230 discloses a centrifugal method to form an ice-crystal layer using a rotating basket. Also it is described that spherical ice crystals are formed by extending a residence time during slow freezing and that fine ice crystals are produced by shortening the residence time during rapid freezing. The U.S. Pat. No. 3,320,153 relates to a technique for separating an oil and a mixture of ice crystals and solidified wax.

b) Formation of Filter Crystals in Gas

A type of formation of filter crystals in gas includes natural snow. Filter crystals can also be formed in gas as artificial snow.

### 3. Characteristics of Filtration

Documents relating to the present invention are described below. 1) A filtration is considered as a method capable of separating a liquid-liquid (a high-viscosity liquid and a low-viscosity liquid) mixture by capturing the high-viscosity liquid by a crystal-filter layer and passing the low-viscosity liquid through the crystal-filter layer. 2) A filtration has the function to coalesce immiscible droplets or and/or fine solids.

### 3.1 Liquid in Filter Layer

a) Based on researches of freeze concentration (separation between ice crystals and concentrate), the Thijssen document describes on pp. 130-132 the following. In a method (press, centrifugal filtration, and washing) for separating between ice crystals and a liquid, a permeation rate (=filtrate amount/time/area) of the liquid is inversely proportional to the viscosity of the liquid and the crystal filter layer thickness (filter-layer-passage distance of the liquid) and is proportional to the square of the mean crystal diameter. The Thijssen document also describes that in centrifugal filtration of ice crystals and a liquid, the amount of the liquid remaining in the filter layer is proportional to the viscosity of the liquid, and that the amount of remaining liquid decreases with increasing centrifugal effect (G).

b) In regard to centrifugal filtration, Sambuichi et al., AlChE J., vol. 33, pp. 109-120 1987 and Perry document pp. 19.96-19.103 describe the following: The permeation flow rate decreases as the viscosity of a liquid increases and the filter layer thickness (the distance for the liquid to pass) increases; In addition, the permeation flow rate increases with increasing centrifugal effect (G) and with increasing rotation time.

### 3.2 Coalescing Function of Filtration

In Spielman et al., Ind. Eng. Chem., vol. 62, No. 10, pp. 10-24 1970, U.S. Pat. No. 4,335,001, and Rege et al., AlChE J., vol. 34, pp. 1761-1772 1988, it is described that the filtrations has the function to coalesce fine solids and/or immiscible droplets in mixtures (such as emulsion) to be separated.

In the document of Spielman et al., it is also described that larger liquid droplets (e.g., larger aggregates), the more easily the liquid droplets are captured by a filter layer.

In the present invention, considering the coalescing function (facilitating subsequent separation) of the filter layer, the coalescing function may be used as pre-treatment for separation of the mixture to be separated regardless of the presence of capture in the filter layer.

The document of Spielman et al. further describes that a difference in permeability occurs between a high-viscosity liquid and a low-viscosity liquid when a mixture of these liquids is passed through the filter layer.

### SUMMARY OF INVENTION

The present invention provides a method and system using a melting soluble filter medium for separating a mixture to be separated (liquid-solid or liquid-liquid mixture). The mixture to be separated is separated into a liquid passing through a crystal-filter layer which is made of the melting filter medium and a captured material captured in the crystal-filter layer.

The present invention has advantages such as the followings:

a) The filter medium and the captured material are separated by melting the filter medium. Thus, the capturing material and the captured material are easily separated.

b) When low-temperature materials such as ice and snow are used as the filter medium, deterioration can be delayed in treatment of a mixture to be separated such as a natural material.

c) In a preferred embodiment of the present invention, components with a small difference in specific gravity in a mixture to be separated can also be separated.

An example of the method according to the present invention includes the step of: a) producing filter crystals by cooling a mother liquid or by adding a liquid to a substance and crushing the crystal; b) providing the mixture including the liquid to be passed and the material to be captured; c) forming a crystal-filter layer of the filter crystals on a supporting wall having holes which supports the crystal-filter layer; d) supplying the mixture to the crystal-filter layer to allow the liquid to pass through the crystal-filter layer and the holes of the supporting wall, while capturing the material by the crystal-filter layer; e) separating from the supporting wall the crystal-filter layer that has captured the material; and f) melting the filter crystals in the crystal-filter layer that has captured the material to allow the filter crystals and the captured material to separate.

### BRIEF DESCRIPTION OF DRAWINGS

FIG. 1 shows a system including a crystal generator, a deliquoring machine, a separator, and a melting tank according to an embodiment of the present invention. In FIG. 1, separation after melting a crystal-filter layer is performed by a gravity settling separation method for a liquid-liquid mixture. In addition, a case where a removed liquid and/or a melt produced in the gravity settling separation method are used as a mother liquid is shown by dotted lines.

FIG. 2 shows a system including a crystal generator, a separator, and a melting tank according to an embodiment of the present invention. In FIG. 2, separation after melting a crystal-filter layer is performed by a gravity settling separation method for a liquid-solid mixture. In addition, a case where a melt produced in the gravity settling separation method is reused as a mother liquid is shown by dotted lines.

FIG. 3 is a schematic drawing of an in-liquid rotating drum-type crystal generator.

FIG. 4 is a schematic drawing of an in-gas low-temperature evaporation-type crystal generator.

FIG. 5 is a schematic sectional view showing an operation of a conveyor-discharge-type-deliquoring machine.

FIGS. 6A, 6B, and 6C are a schematic sectional view showing an operation of a filter-cloth-inverting-type separator. FIG. 6A shows an operation during supply of filter crystals, FIG. 6B shows an operation during supply of a mixture to be separated, and FIG. 6C shows an operation during discharge of a crystal-filter layer that has captured a material.

FIG. 7 is a schematic sectional view showing an operation of a drum filtration-type separator.

FIGS. 8A and 8B show conditions of holes of a crystal-filter-layer-supporting wall having holes. FIG. 8A is an arrangement of the holes on a surface of the supporting wall, and FIG. 8B is an enlarged sectional view of the supporting wall and a crystal-filter layer that has captured a material.

FIG. 9 is a schematic sectional view showing a disk-type centrifugal separator.

### DETAILED DESCRIPTION OF THE INVENTION

1. Outlines of System and Apparatuses

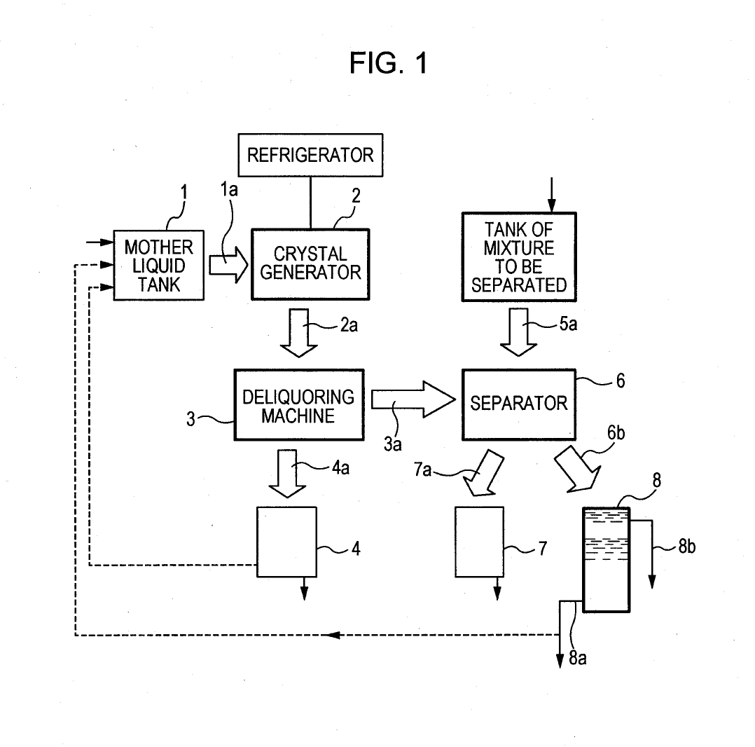

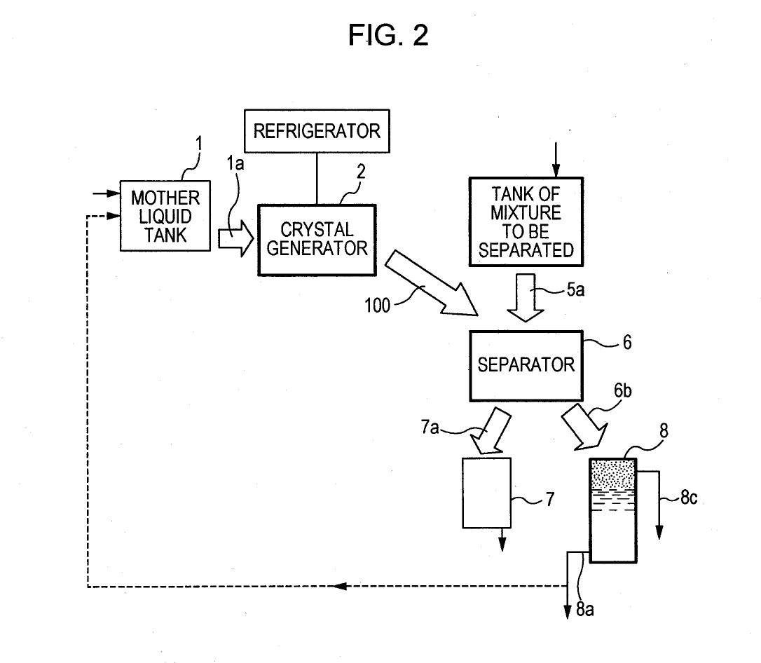

FIGS. 1 and 2 show typical examples of a system of the present invention for separating a mixture to be separated using a melting filter medium. A system shown in FIG. 1 includes a crystal generator 2, a deliquoring machine 3, a separator 6, and a melting tank 8. A system shown in FIG. 2 includes a crystal generator 2, a separator 6, and a melting tank 8. In the present invention, the system may be installed in a cooling environment such as a cooling room or chamber. Outlines of each of the apparatuses constituting the system are described below.

1) Crystal Generator 2

The crystal generator 2 is an apparatus for producing mother liquid crystals 2a by cooling a mother liquid 1a. The mother liquid crystals 2a are crystals, a mixture of crystals and the mother liquid 1a, filter crystals 100, or a mixture of the filter crystals 100 and the mother liquid 1a. When the mother liquid 1a is a multi-component liquid, a liquid in the mixture has a solute concentration different from the mother liquid 1a. The mother liquid crystals 2a are introduced to the deliquoring machine 3, the separator 6, or a deliquoring separator described below.

2) Deliquoring Machine 3

The deliquoring machine 3 is an apparatus that forms deliquored filter crystals 3a. The mother-liquid crystals 2a from crystal generator 2 are deliquored by the movement of the liquid (the mother liquid) in the mother-liquid crystals 2a through a mother-liquid-crystals-supporting wall (such as a basket- or drum-like wall, a filter cloth or a screen) having holes in the deliquoring machine 3 (due to centrifugal force, differential pressure, or combination thereof) to form the deliquored filter crystals 3a (removed liquid is referred to as a “deliquored liquid” 4a). Alternatively, the deliquoring is combined with such as high-speed-rotation-crystal-impact (ejection) grinding or crystal crushing to form the deliquored filter crystals 3a. The deliquored filter crystals 3a are filter crystals, or a mixture of filter crystals and deliquored liquid 4a. The deliquoring efficiency may be low. The deliquored liquid 4a is passed to a deliquored liquid tank 4. The deliquored filter crystals 3a are introduced to the separator 6.

The deliquored liquid 4a may be reused as the mother liquid 1a (to the crystal generator 2). Reuse of the deliquored liquid 4a may be of a low running cost, low total cost and energy-saving system by supplying deliquored liquid 4a (as mother liquid 1a) to the mother-liquid tank 1, by reducing energy for cooling (or heating) mother liquid 1a, and by reducing the amount of disposal of the deliquored liquid 4a. When the mother liquid 1a is a multi-component liquid, the deliquored liquid 4a has a solute concentration different from the mother liquid 1a. In this case, the deliquored liquid 4a may be adjusted to the same solute concentrated as the mother liquid 1a.

3) Separator 6

The separator 6 is an apparatus that separates the mixture to be separated (liquid-liquid, liquid-solid) by a crystal-filter layer 6a and a crystal-filter-layer-supporting wall having holes. The crystal-filter-layer-supporting wall having holes is, for example, a basket-shaped-supporting wall or a drum-shaped-supporting wall, a filter cloth, and a screen. The deliquored filter crystals 3a from the deliquoring machine 3 or the mother liquid crystals 2a from the crystal generator 2 are introduced to the separator 6, forming a filter layer (hereinafter the “crystal-filter layer” 6a) including the crystals as the filter medium in the separator. Natural snow may be introduced as the filter crystals to the separator. The deliquored filter crystals 3a, the mother liquid crystals 2a, or the filter crystals, which are introduced to the separator, may be accompanied by the liquid. Next, the mixture 5a to be separated is supplied to a surface of the crystal-filter layer 6a (in which centrifugal force, differential pressure, or combination thereof is exerted in the separator 6). The mixture 5a to be separated is separated into a passing liquid 7a which passes through the crystal-filter layer 6a and the crystal-filter-layer-supporting wall having holes, and a captured material captured in the crystal-filter layer. When the mixture 5a to be separated is a liquid-liquid mixture, a low-viscosity liquid (such as an aqueous solution) in the mixture to be separated passes through the crystal-filter layer 6a and the crystal-filter-layer-supporting wall having holes, and discharged to the outside of the crystal-filter-layer-supporting wall, while a high-viscosity liquid 8b (such as oil) is captured in the crystal-filter layer. On the other hand, when the mixture 5a to be separated is a liquid-solid mixture, a liquid in the mixture to be separated passes through the crystal-filter layer 6a and the crystal-filter-layer-supporting wall having holes, and discharged to the outside of the crystal-filter-layer-supporting wall, while solids 8c are captured in the crystal filter-layer 6a. Further, when a liquid in a liquid-solid mixture includes a liquid and an immiscible liquid like in the liquid-liquid mixture, the high-viscosity liquid may be or not be captured in the crystal-filter layer according to applications of the present invention. Further, for the purpose of separating multiple types of immiscible liquids in liquid-liquid or liquid-solid mixtures, the present invention may be used as a method and system for separating a high-viscosity liquid and a low-viscosity liquid in immiscible liquids on the basis of the same principle (a difference in viscosity between immiscible liquids) as in the liquid-liquid mixture.

In addition, the mother liquid crystals 2a formed by the crystal generator 2 may be introduced to a deliquoring separator. The deliquoring separator continuously performs the operations of the deliquoring machine 3 and the separator 6 in a single apparatus. Through (a) a step of supplying mother liquid crystals, (b) a step of deliquoring the mother liquid crystals, (c) a step of supplying the mixture to be separated, and (d) a step of discharging the crystal-filter layer that has captured a high-viscosity liquid and/or solids, in the deliquoring separator, a low-viscosity liquid in the mixture 5a to be separated which is supplied in step (c) passes through the crystal-filter layer and the crystal-filter-layer-supporting wall having holes, while a high-viscosity liquid and/or solids are captured in the crystal-filter layer.

In the present invention, before supplying the mixture 5a to be separated, the temperature of the mixture 5a to be separated may be decreased to produce a solidified matter (such as the same material as the filter crystals, or solidified oils) in the mixture 5a to be separated. An example of the present invention method where the solidified matter in the mixture 5a to be separated is the filter crystal is described with reference to a filter aid (below after 0057). Also, the present invention may be used as a separation (such as wintering) method and system utilizing a difference in freezing point.

After the above-described operations, the liquid 7a passing through the crystal-filter layer 6a and the crystal-filter-layer-supporting wall is introduced to a passing liquid tank 7. In addition, the crystal-filter layer 6a and the captured material are introduced to a device (such as melting tank 8) for melting the crystal-filter layer. The captured material includes the high-viscosity liquid and/or the solids captured in the crystal-filter layer 6a. Hereinafter, the crystal-filter layer that has captured the captured material is referred to as a CFLC. In addition, in the present invention, the same as the passing liquid 7a or components thereof may be captured in the CFLC 6b within a range in which the intended purpose of the system of the present invention can be achieved.

4) Melting of Crystal-Filter Layer

The crystal-filter layer (i.e., the filter crystals) in the CFLC is melted with the device for melting the crystal-filter layer (hereinafter, a material melted the crystal-filter layer is referred to as a “melt”. The melt may be contaminated with the captured material). The melting is performed by heating (such as by using a heater or exploiting difference temperature between the inside and outside of a melting device). During melting of the crystal-filter layer, the solids (e.g., solidified oils) in the CFLC may be or not melted according to the intended purpose of the system according to the present invention.

The melt 8a that is separated after melting may be used (reused) as the mother liquid 1a of the crystal generator 2. In this case, the reuse of the melt 8a may be of a low running cost, low total cost and energy-saving system by supplying the melt 8a (as the mother liquid 1a) to the mother-liquid tank 1, by reducing energy for cooling (or heating) the mother liquid 1a, and by reducing the amount of disposal of the melt 8a. Also, the reuse of the melt 8a has the possibility of decreasing the filter medium cost for changing the filter medium and/or the cost for treating (such as disposal) the filter medium after use as compared with conventional filtration.

2. Details of System and Apparatuses

Details of the apparatuses constituting the system and the system of the present invention are described below.

1) Crystal Generator 2

The crystal generator 2 is an in-liquid or in-gas type apparatus. In the in-liquid type apparatus, crystals are generated (solidification of the mother liquid) using a cooled solid (such as metal) or a cooled fluid (gas and/or liquid) (made contact with the mother liquid) in the mother liquid, and the crystals are removed or scraped. In the in-gas type apparatus, the mother liquid is mixed in a gas by low-temperature evaporation, heating evaporation, spraying, or liquid dropping, the resultant mixture is made contact with a cooled solid (such as metal) or a solid (such as plastic) to produce crystals (solidification of the mother liquid), and the crystals are removed or scraped.

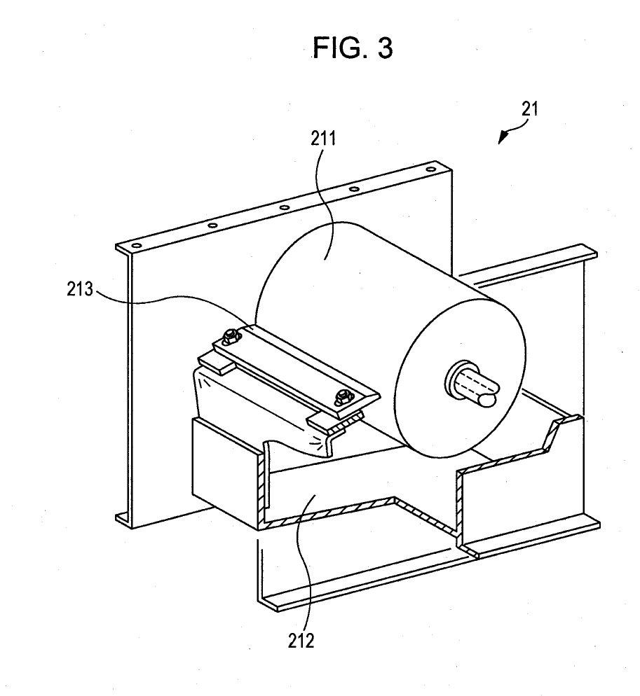

The in-liquid type apparatus for making the crystals on the cooled solid includes types such as a rotating drum type (such as 21 in FIG. 3), and an internally scraping drum type. Among these, the internally scraping drum type includes types such as an internally scraping heat exchanger type, an annular space scraping type, and an auger type. The general characteristics of these in-liquid type apparatuses are described in the documents below. The rotating drum type is described in U.S. Pat. No. 6,233,953 B1 and Okabe, T., Dechema-Monographien, BAND 47, pp. 815-821 1962. The internally scraping heat exchanger type is described in the Thijssen document p. 116, the annular space scraping type is described in Frytherm: Company Frymakoruma, Neuenburg. Germany, and the auger type is described in U.S. Pat. No. 4,497,184. The cooled solid is generally cooled using a refrigerator. However, when the mother liquid is at high temperature, the cooled solid may be cooled by, for example, fan cooling, and water cooling without using a refrigerator. When the cooled solid is cooled with a refrigerator, a cooling medium may be either refrigerant or brine. the in-liquid type apparatus for producing the crystals (solidification of the mother liquid) using the cooling fluid (gas and/or liquid), examples of the cooling gas include normal butane gas or iso-butane gas (Wiegandt, Herbert F., Advance in Chemistry Series, No. 27, pp. 82-89 1960), and examples of the cooling liquid include an inert-antifreezing liquid (e.g., hydrofluoroether 3M Co., USA).

The in-gas type apparatus includes an evaporation type, a spraying type and a dropping type, and methods thereof include a low-temperature evaporation method (Seki et al., Trans. of the JSRAE, vol. 25, pp. 325-335 2008), a heating evaporation method, an ultrasonic method, a centrifugal method, a high-pressure spraying method, and a two-fluid spraying method. The term “low-temperature evaporation” represents that a liquid of 0° C. or more (boiling point or less) is made contact with a gas of 0° C. or less to mix vapor and/or fine droplets of the liquid in the gas.

Also, an apparatus of a type in which the mother liquid 1a is dispersed on a cooled surface to produce a solidified matter, which is then scraped, can be used as the crystal generator 2.

The crystal generator 2 may be a crushing-type apparatus in which mass or lump crystals are crushed to produce the filter crystals. The mass or lump crystals may be produced by cooling the mother liquid or by adding a liquid to a substance. For example, the former crystals are ice crystals produced by cooling water and the latter crystals are trimethylolethane-hydrate (TME.3H₂O) crystals produced by adding water to TME powder (Teduka et al., AIChE J., vol. 60(1), pp. 22-26 2014; the disclosure of which is hereby incorporated by reference). In order to produce the TME.3H₂O crystals, a mixture is prepared by adding water to TME powder to allow the TME solids to melt. The mixture may be heated to melt the TME solids. The mixture may be cooled to produce the TME.3H₂O crystals. Excessive water in the mixture may further be removed by discharging and/or drying. The mixture after the removal of water may also be a mixture of the TME solids and the TME.3H₂O crystals.

The crushed crystals may be sieved by a sieve device to improve separation efficiency, in which device the crushed crystals are sieved for obtaining a certain controlled size. The size of the crushed and sieved crystals (as the filter crystals) is preferably within a certain range (e.g., from 0.1 mm to 0.2 mm). The crushing and sieving steps may be repeated if necessary.

The mother liquid 1a may be continuously or discontinuously supplied in a necessary amount to the crystal generator 2 from the mother liquid tank 1. The temperature of the mother liquid in the mother liquid tank 1 may be controlled to a necessary temperature by, for example, a heater.

The shape and size of crystals produced by the crystal generator are adjusted by controlling the conditions such as the temperature and the moving velocity of the cooled solid, the solid or the cooled fluid, and the removal or scraping rate of crystals. Devices for removing or scraping crystals include a rotating brush, a scraper, and a gas sprayer.

2) Deliquoring Machine 3, Separator 6, and Deliquoring Separator

Any one of the deliquoring machine 3, the separator 6, and the deliquoring separator can use methods and apparatuses using various filtration techniques (gravitation, pressure application, and pressure reduction) (Perry document, pp. 19.65-19.103) including a centrifugal filtration method (i.e., centrifugal filters: Perry document, pp. 19.96-19.100). Among the various filtration techniques, the centrifugal filtration method using a rotating basket as the crystal-filter-layer-supporting wall having holes and a drum filtration method (i.e., rotary drum filters: Perry document, pp. 19.79-81) using a rotating drum as the crystal-filter-layer-supporting wall having holes are described below. The number of the holes of the crystal-filter-layer-supporting wall may be not many, and the hole shape on the wall may be long and narrow.

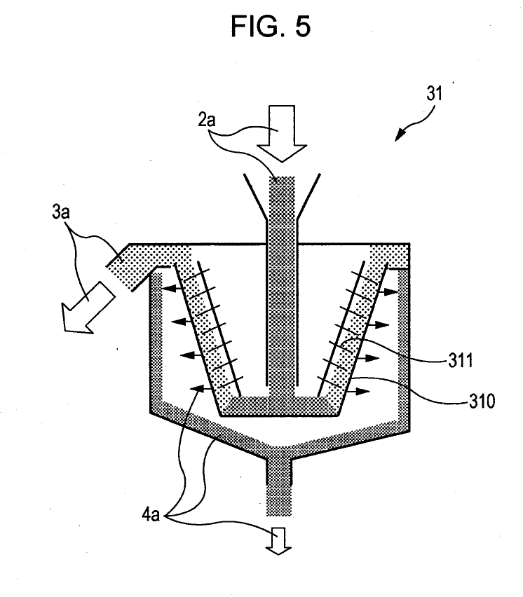

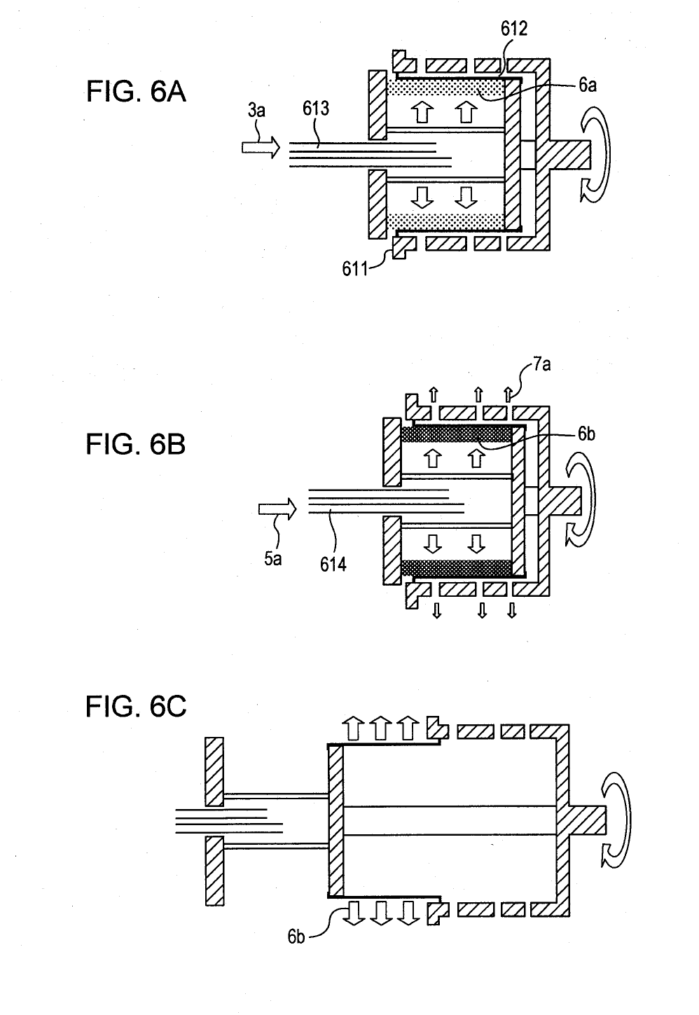

The centrifugal filtration method uses a discontinuous or continuous apparatus described below. The discontinuous apparatus includes a filter-cloth-inverting type (such as FIGS. 6A, 6B, and 6C), a batch-automatic type, and an open-bottom basket type, and the continuous apparatus includes a conveyor discharge type (e.g., 31 in FIG. 5), an extrusion type, and a self-discharge type. The general characteristics of these apparatuses are described in the documents below. The filter-cloth-inverting type is described in U.S. Pat. No. 7,168,571 B2. The batch-automatic type (e.g., peller centrifuges), the open-bottom basket type, the conveyor discharge type, the extrusion type (e.g., pusher centrifuges), and the self-discharge type are described in Zeitsch, K., Centrifugal Filtration, In Liquid-Solid Separation, 3rd Ed., Butterworths, London, pp. 509-530 1990 and the Perry document, pp. 19.96-19.100. Further, “Dehydrator” (Saito Separator Limited, Japan) is the conveyor discharge type, and Tanabe Willtec Inc. Japan has the extrusion type. In the conveyor discharge type and the extrusion type, rotating baskets include a vertical type and a horizontal type, and the shapes of the baskets include a drum shape and a conical shape.

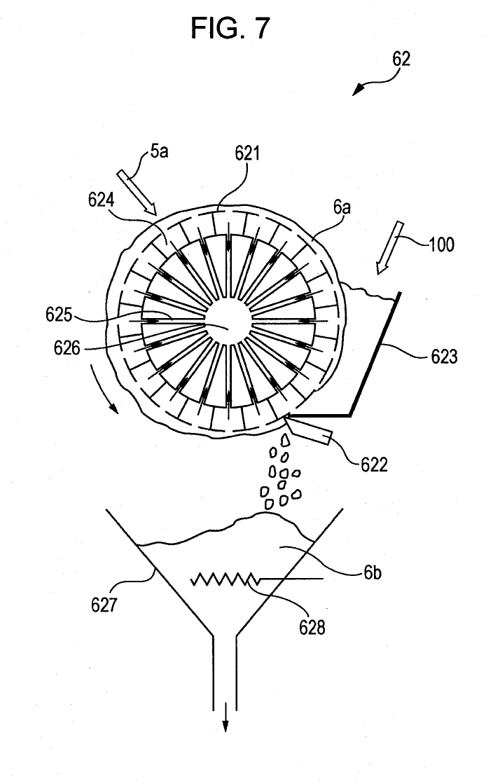

On the other hand, the drum filtration method (Perry document pp. 19.65-19.89) includes a pressure method, a pressure reduction method (such as 62 in FIG. 7), and a combination thereof.

The drum filtration method by producing crystals in the liquid tank in which the drum is immersed can be used for the crystal generator, or for an apparatus serving as the crystal generator and the deliquoring machine, or for an apparatus serving as the crystal generator, the deliquoring machine and the separator. In this case, as means for generating the crystals in the liquid tank, a cooled surface for formed crystal and a scraping blade for scraped the crystal from the cooled surface are provided in the liquid tank, or a cooled gas or a cooed antifreezing liquid is introduced into the liquid tank.

2.1) Crystal-Filter-Layer-Supporting Wall Having Holes

When the crystal-filter-layer-supporting wall having holes is used in the separator 6 or the deliquoring separator, the average distance between the holes (between outer edges of the holes) of the supporting wall is preferably larger than the average thickness of the CFLC on the supporting wall. The thickness of the CFLC is the distance between the surface of the CFLC and the surface of the supporting wall having the hole. In this case, the total opening area of the holes of the supporting wall having holes is smaller than the surface area of the wall excluded the opening area of the holes of the wall.

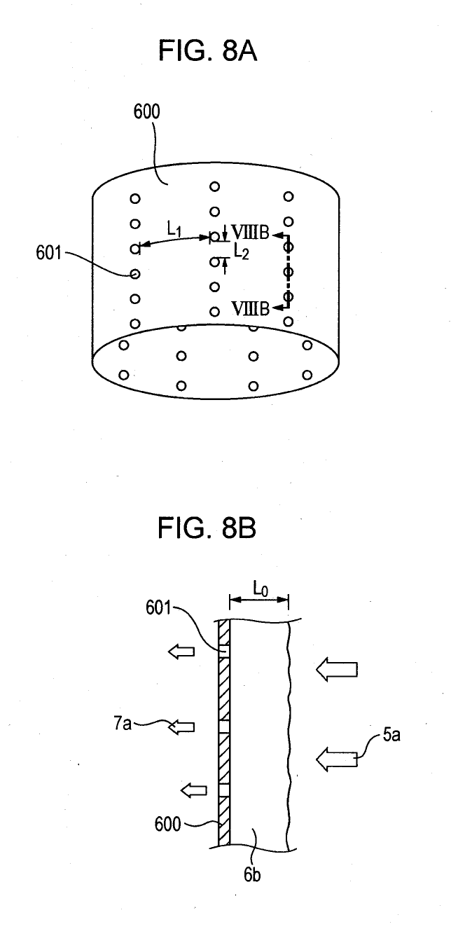

This is clearly explained with reference to FIGS. 8A and 8B. FIGS. 8A and 8B show an example of a relation between a CFLC 6b and a crystal-filter-layer-supporting wall 600 having holes in the case of the basket-type crystal-filter-layer-supporting wall 600 having holes. FIG. 8A shows an example of an arrangement of holes of the supporting wall surface. FIG. 8B is a sectional view of the supporting wall and the CFLC 6b when the mixture 5a to be separated is supplied to the crystal-filter layer using the supporting wall. In FIG. 8A, L1 and L2 each denote the distance between the holes 601 of the supporting wall surface. On the other hand, in FIG. 8B, L0 denotes the average thickness of the CFLC. The above description means that the average distance L12 (=(L1+L2)/2) between the holes 601 of the supporting wall surface is larger than L0 (L12>L0).

The above conditions of the supporting wall having the holes causes the following phenomena:

a) The ratio of flow quantity and the flow distance of the mixture to be separated along the surface of the supporting wall, after flowing through the filter layer from the surface of the filter layer and reaching the surface of the supporting wall, are increased. This increases the average flow distance of the mixture to be separated (per unit volume) in the filter layer.

b) The crystal-filter medium is compressed to the supporting wall surface due to differential pressure (such as centrifugal force). Therefore the mixture to be separated at the above-described ratio of flow quantity (after reaching the supporting wall surface from the filter layer surface) is forced to be moved along the supporting wall surface through the compressed narrow gap between the supporting wall surface and the filter crystals, and also through the narrowed gaps between filter-crystals in the vicinity of the supporting wall surface.

These phenomena significantly increase the capture rate of material captured in the crystal-filter layer (=amount of material captured in crystal-filter layer/amount of crystal-filter layer/supply amount of mixture to be separated). This indicates that the amount of the crystal-filter medium can be decreased for a higher capture rate of the separator or the deliquoring separator. In addition, the phenomena have the possibility of enhancing the effect of coalescing immiscible droplets and/or fine solids in the mixture to be separated.

2.2) Others

The mother liquid crystals 2a, the deliquored filter crystals, or the filter crystals are preferably supplied to the deliquoring machine 3, the separator 6, and the deliquoring separator using a screw feeder or a tube conveyor.

In addition, the mixture 5a to be separated is preferably supplied to the crystal-filter layer in the separator or the deliquoring separator by spraying.

When the centrifugal filtration method is applied to the deliquoring machine 3, the separator 6, and the deliquoring separator, a component such as a screen or a filter cloth, which rotates together with the basket, may be provided inside the basket. When the drum filtration method is applied to the deliquoring machine 3, the separator 6, and the deliquoring separator, a component such as a screen or a filter cloth or, which rotates together with the drum, may be provided outside the drum.

The shape and size of the deliquored filter crystals 3a produced by using the centrifugal filtration method in the deliquoring machine are preferably controlled by selecting the conditions such as the amount of the mother liquid crystals 2a supplied, the discharge rate of the deliquored filter crystals, and the rotational speed of the basket according to purposes of use of the system.

Besides the conditions of the crystal-filter-layer-supporting wall, the operation conditions of the separator and the deliquoring separator are preferably selected so as to increase the capture rates by the crystal-filter layer. The operation conditions include the supply amounts and supply rates of the mother liquid crystals 2a, the deliquored filter crystals, the filter crystals and the mixture 5a to be separated, and the differential pressure (such as centrifugal force) of the crystal-filter. When the separator or the deliquoring separator using the centrifugal filtration method is used for separating the liquid-liquid mixture, the time required for one filtration is preferably short (several seconds or minutes) in order to increase the capture rate of the high-viscosity liquid capturing by the crystal-filter layer (to decrease the discharge of the captured high-viscosity liquid from the CFLC). The “time required for one filtration” represents the time required from supply of the mixture to be separated to the crystal-filter layer to discharge of the CFLC from the basket.

In the present invention, the filter crystals may be used as a filter aid in the separator 6 and the deliquoring separator (pre-coating method or body feed method) (Perry document, p. 19.85).

3) Melting of Crystal-Filter Layer

After the above-described operations, the liquid 7a passing through the crystal-filter layer and the crystal-filter-layer-supporting wall is introduced to the passing liquid tank 7. The crystal-filter layer in the CFLC is melted using the melting device. The melting may be performed by the melting tank 8 or a system including the heater or the like provided in the course thereof without using the melting tank. Further, the melting may be performed in the separator. When the melting is performed in the separator, the melting may be accompanied with a gravity settling separation (gravity separation due to a difference in specific gravity).

The mixture (the melt, the high-viscosity liquid and/or the solids) after melting can be separated by separation means such as the gravity settling separation method, a disk-type centrifugal separation method (Perry document, pp. 19.92-19.94), a tubular centrifugal separation method, a continuous decanter separation method (Perry document, pp. 19.94-19.95), and a method and apparatus using a membrane, a filter (Perry document, pp. 19.65-19.89), or a coalescer (Perry document, pp. 21.65-21.66).

When the melting tank 8 is used, the gravity settling separation method can be performed in the tank.

The melt 8a, the low-viscosity liquid, the high-viscosity liquid 8b, and the solids 8c separated by the above-described separation technique may be contaminated with the material (or the materials) contained in the mixture to be separated and/or in the melt (in amounts within a range in which the object of the preset invention can be achieved). In the whole description of this patent, even when the melt 8a, the low-viscosity liquid, the high-viscosity liquid 8b, and the solids 8c separated by the system of the present invention are contaminated with the other material (or the materials) (in amounts within a range in which the object of the preset invention can be achieved), the same expression (the melt 8a, the low-viscosity liquid, the high-viscosity liquid 8b, and the solids 8c) is used.

4) System

Each of the apparatuses and devices for the crystal generator 2, the deliquoring machine 3, the separator 6, the deliquoring separator, the crystal-filter-layer-melting device, and the device for separating the mixture after melting can be used to make the combination for the system in the present invention.

The combination may be used as pre-treatment means for the above-described various separation means such as the disk-type centrifugal separation method, the drum-type centrifugal separation method, the continuous decanter separation method, and the method and apparatus using the membrane, the filter, or the coalescer. For example, the disk-type centrifugal separation method may be used for increasing the purity of the captured material or the melt separated from the CFLC by the gravity settling separation method, or the purity of the passing liquid passing through the crystal-filter layer and the crystal filter layer supporting wall. Further, the separation means may be used for separating a mixture containing a mixture in the passing liquid tank and a mixture after melting the filter crystals in CFLC.

In the present invention, considering the coalescing function (facilitating subsequent separation) of the crystal filter layer, the coalescing function may be used as pre-treatment for separation of the mixture to be separated regardless of the presence of capture in the crystal filter layer.

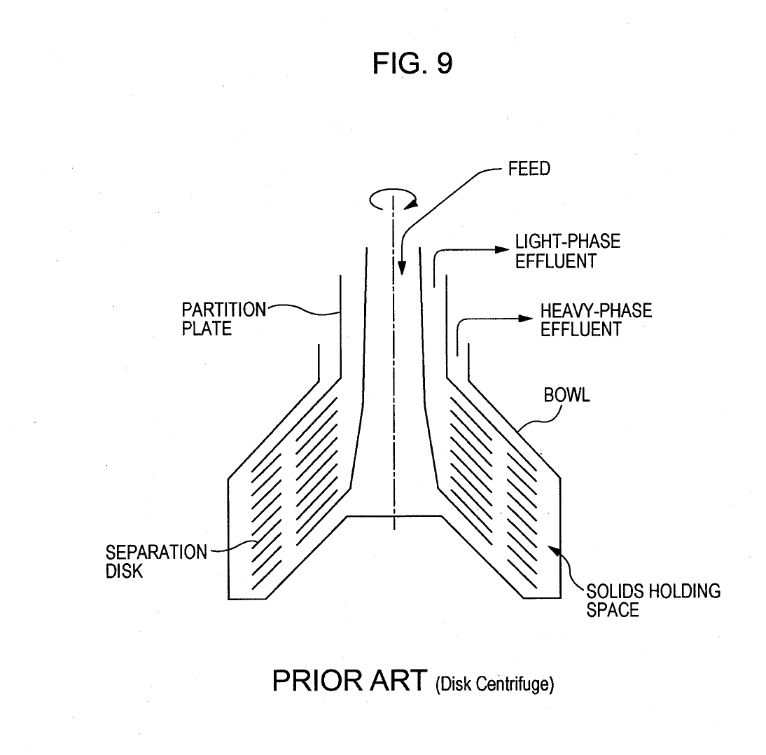

The above-mentioned disk-type centrifugal separation is a method that applies strong centrifugal force, which is produced by a high-speed rotor (separation disk), to a mixture to be separated, thereby causing a difference in movement velocity between components in the mixture to be separated and resulting in separation of the components. Therefore, the separating ability is proportional to a difference in specific gravity between a dispersion medium and an immiscible liquid (and/or solids) in the mixture to be separated, and is reversely proportional to the viscosity of the dispersion medium. This technique is well known as a separation technique for liquid-liquid (light liquid and heavy liquid) or liquid-solid (solids and liquid or solids, light liquid, and heavy liquid). The structure and principle of the technique of disk-type centrifugal separation method (Disk centrifuge) are described in, for example, the Perry document, pp. 19.92-19.94. FIG. 9 is a schematic sectional view showing an example of the disk-type centrifugal separator described in the document.

The system of the present invention may continuously or discontinuously (batch) treat the mixture 5a to be separated according to purposes of use. In addition, the system may be various sizes according to purposes of use.

3. Preferred Modes of System

Preferred modes 1 and 2 of the system are described below.

1) Preferred Mode 1

Preferred mode 1 (FIGS. 1, 3, 5, 6A, 6B, and 6C) relates to the system (FIG. 1) including the crystal generator 2, the deliquoring machine 3, the separator 6, and the melting tank 8. In the preferred mode 1, the crystal generator 2 is the in-liquid-rotating drum type 21 (FIG. 3), the deliquoring machine 3 is the centrifugal conveyor discharge type 31 (FIG. 5), the separator 6 is the centrifugal-filter-cloth-inverting type (FIGS. 6A, 6B, and 6C), the crystal-filter layer is melted in the melting tank 8, and the mixture after melting (or during melting) is separated by the gravity settling separation method.

In addition, the mother liquid 1a is a NaCl solution (sterilized seawater), and the filter crystals are ice crystals. The mixture to be separated is a liquid-liquid mixture.

The mother liquid 1a is introduced from the mother liquid tank 1 to the in-liquid-rotating drum type crystal generator 21 (FIG. 3) described below.

In this mode, the rotating drum-type crystal generator 21 (FIG. 3) includes a rotating drum 211, a rotating drum mother liquid tank 212, and a rotating-drum-scraping blade 213. The mother liquid 1a is introduced from the mother liquid tank 1 to the rotating drum mother liquid tank 212. A refrigerant flows on the back of the outer surface of the rotating drum. When a lower part of the rotating drum 211 is immersed in the mother liquid 1a in the rotating drum mother liquid tank 212, crystals are produced on the outer surface of the drum, and thus the mother liquid crystals 2a are formed on the outer surface of the drum with rotation of the rotating drum 211. The mother liquid crystals 2a formed on the outer surface of the drum are continuously separated from the outer surface of the rotating drum with the rotating-drum-scraping blade 213 provided close to the outer surface of the drum. The mother liquid crystals 2a are a mixture of the crystals and the mother liquid.

The mother liquid crystals 2a formed by the crystal generator 2 are introduced to the conveyor-discharge-type-deliquoring machine 31 (FIG. 5) disposed below the crystal generator 2. The mother liquid crystals 2a are a mixture of the crystals and the mother liquid.

In this mode, the conveyor-discharge-type-deliquoring machine 31 operates as described below. In this case, a basket 310 having holes is a vertical type with a conical shape widening upward. The mother liquid crystals 2a are introduced from the crystal generator 2 to the bottom of the rotating basket 310 having holes. The mother liquid crystals 2a that go into the bottom of the basket 310 receive centrifugal force of the rotating basket 310 having holes and diffuse on the inner wall of the basket 310. The diffused mother liquid crystals 2a are deliquored by rotation centrifugal force of the basket 310 while being moved upwardly on the inner wall of the rotating basket by a screw-shaped scraping blade 311 which rotates (at a differential rate from rotation of the basket) near the inner surface of the basket 310. The deliquored filter crystals 3a are discharged from the top edge of the basket. The discharged deliquored filter crystals 3a are introduced to a deliquored filter crystal tank (not shown) disposed below the deliquoring machine 31. On the other hand, the deliquored liquid 4a is introduced to the deliquored liquid tank 4. The deliquored liquid 4a in the deliquored liquid tank 4 is introduced to the mother liquid tank 1 after adjustment (not shown) of the concentration and is reused as the mother liquid 1a.

The deliquored filter crystals 3a in the deliquored filter crystal tank are introduced to the filter-cloth-inverting-type separator by a screw feeder.

In this mode, the filter-cloth-inverting-type separator operates as described below. The general characteristics of the filter-cloth-inverting-type separator are described in U.S. Pat. No. 7,168,571 B2.

(a) The deliquored filter crystals 3a in the deliquored filter crystal tank are introduced to a filter cloth 612 (the filter cloth rotates together with a basket 611) attached to the inner side of the rotating basket (crystal-filter-layer-supporting wall having holes) 611 by a screw feeder 613. The introduced deliquored filter crystals 3a form the crystal-filter layer 6a on the filter cloth (FIG. 6A).

(b) The mixture 5a to be separates is sprayed on the surface of the formed rotating crystal-filter layer 6a through a supply pipe 614 for the mixture to be separated. A low-viscosity liquid in the sprayed mixture 5a to be separated passes through the crystal-filter layer and the crystal-filter-layer-supporting wall having holes, while the a high-viscosity liquid 8b is captured in the crystal-filter layer (FIG. 6B).

(c) The supply of the mixture 5a to be separated is stopped. Then, the CFLC 6b is separated from the filter cloth (due to centrifugal force) by inverting (turning inside out) the filter cloth 612. The separated CFLC 6b is discharged from the bottom (not shown) of the separator (FIG. 6C).

After the above-described operations, the passing liquid 7a (low-viscosity liquid) passing through the crystal-filter layer and the crystal-filter-layer-supporting wall having holes is introduced to the passing liquid tank 7. The CFLC 6b is introduced to the melting tank 8. The crystal-filter layer is melted by heating (heater: not shown) in the melting tank 8. The mixture heated in the melting tank 8 is separated into the high-viscosity liquid 8b and the melt 8a due to a difference in specific gravity (gravity-settling separation).

2) Preferred Mode 2

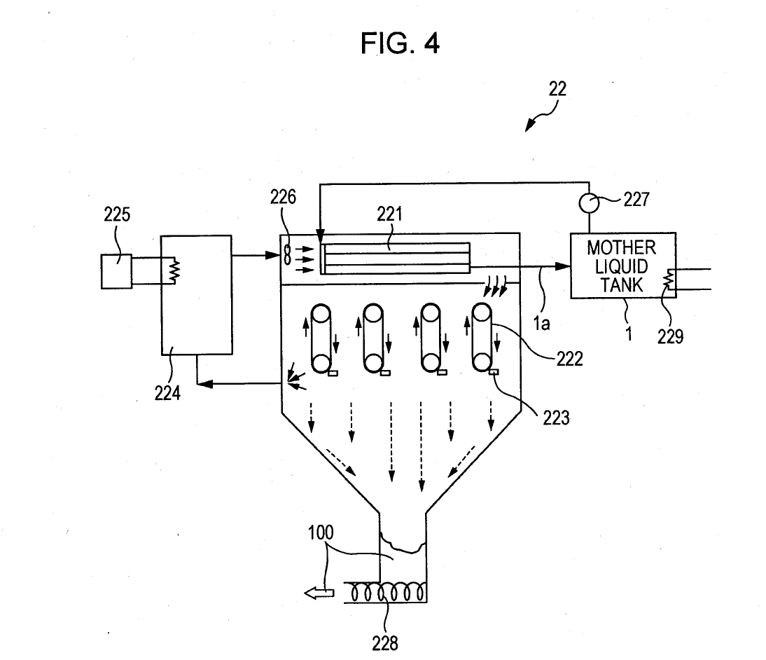

Preferred mode 2 (FIGS. 2, 4, and 7) relates to the system (FIG. 2) including the crystal generator 2, the separator 6, and the melting tank 8. In the preferred mode 2, the crystal generator 2 is the in-gas low-temperature evaporation type 22 (FIG. 4), the separator 6 is the reduced-pressure drum filtration type 62 (FIG. 7), the crystal-filter layer is melted in the melting tank 8, and the mixture after melting (or during melting) is separated by the gravity settling separation method.

In addition, the mother liquid 1a is water, and the filter crystals are ice crystals. The mixture to be separated is a liquid/solid mixture.

The mother liquid 1a is introduced from the mother liquid tank 1 to the low-temperature evaporation-type crystal generator 22 (FIG. 4).

In this mode, the low-temperature evaporation-type crystal generator 22 includes a humidifier 221, a rotary ventilation filter 222, a crystal-scraping device 223, and a cooling room 224. The operations thereof are as follows: A gas is cooled in the cooling room 224. The cooled gas is introduced into the humidifier 221 by a fan 226. The cooled gas introduced into the humidifier 221 is mixed with a mother liquid vapor evaporated (and/or fine droplets) from the mother liquid 1a at a temperature of 40° C. The cooled gas mixed with the mother liquid 1a is introduced into the rotary ventilation filter 222 on which crystals (solidification of the mother liquid 1a) are produced. The crystals formed on the ventilation filter 222 are removed with the crystal-scraping device 223 to make the filter crystals 100. The cooled gas (which may contain the unsolidified mother liquid) passed through the ventilation filter 222 is returned to the cooling room 224. The cooled gas (which may contain the unsolidified mother liquid) is circulated by the above-described step. The rotary ventilation filter 222 is made of a gas-permeable material such as synthetic resin fibers. The cooling room 224 is provided with a cooler 225 and also provided with the function (not shown) to control the temperature of cold gas to the ventilation filter 222. The mother liquid 1a in the humidifier 221 is supplied from a mother liquid tank 1, and the mother liquid is controlled to a necessary temperature by a heater 229. The crystal-scraping device 223 is a scraper provided close to the ventilation filter 222.

The filter crystals 100 formed in the crystal generator 22 are introduced to a crystal reservoir 623 of the drum filtration-type separator 62 (FIG. 7) by a screw feeder 228.

In this mode, the drum filtration-type separator 62 (FIG. 7) is as follows: The drum filtration-type separator 62 includes a rotating drum, the crystal reservoir 623, and a drum-scraping blade 622. In addition, a plurality of small chambers 624 communicating with the holes of a surface material 621 of the drum are equipped on the back of the surface material of the rotating drum. Each of the small chambers 624 is connected to a central reduced-pressure chamber 626 through a pipe 625. The drum filtration-type separator operates as described below. The filter crystals 100 formed in the crystal generator 22 are introduced to the crystal reservoir 623 by the screw feeder 228. When the outer surface of the rotating drum passes through the crystal reservoir 623, then the filter crystals 100 are attached to the outer surface of the drum due to a reduced pressure of holes of the surface material 621, thereby forming a crystal-filter layer 6a. The mixture 5a to be separated is sprayed on the crystal-filter layer 6a formed from the crystal reservoir 623 by rotation of the drum. A liquid in the sprayed mixture 5a to be separated passes through the crystal-filter layer 6a and the crystal-filter-layer-supporting wall 621 having holes due to the reduced pressure communicated through the holes of the drum, while solids 8c are captured in the crystal-filter layer. The CFLC 6b is separated, by rotation of the drum, from the outer surface of the drum 621 with the drum-scraping blade 622 provided close to the outer surface of the drum. The separated CFLC 6b falls in a CFLC receiver 627. The crystal-filter layer in the CFLC 6b is melted with a heater 628 in the CFLC receiver 627. The melted mixture is passed to a gravity-settling separation tank (not shown) disposed below the capturing crystal layer receiver 627 and is separated into the solids 8c and the melt 8a due to a difference in specific gravity in the gravity-settling separation tank. On the other hand, the liquid passing through the crystal-filter layer 6a and the crystal-filter-layer-supporting wall 621 having holes enters the small chambers 624 and then enters the central reduced-pressure chamber 626 from the small chambers 624 through the pipes 625, and is introduced into the passing liquid tank 7 outside the drum.

### INDUSTRIAL APPLICABILITY

The present invention is suitable for a case in which ice is used as filter crystals, and natural materials (mixtures of an aqueous solution and either or both of oil and solids immiscible in the aqueous solution) are used as a mixture to be separated. Utilization of natural products is rapidly extending in the various fields such as energy, medicines, foods, and raw materials. However, relating techniques frequently have difficulty in separating the natural materials, and face high cost and/or low quality of products.

1. A method for separating a mixture into a liquid and a material by using a melting filter medium, the method comprising the steps of:
producing filter crystals by cooling a mother liquid;
providing the mixture including the liquid to be passed and the material to be captured;
forming a crystal-filter layer of the filter crystals on a supporting wall having holes which supports the crystal-filter layer;
supplying the mixture to the crystal-filter layer to allow the liquid to pass through the crystal-filter layer and the holes of the supporting wall, while capturing the material by the crystal-filter layer;
separating from the supporting wall the crystal-filter layer that has captured the material; and
melting the filter crystals in the crystal-filter layer that has captured the material to allow the filter crystals and the captured material to separate.

2. The method according to claim 1, wherein the step of producing filter crystals comprises: deliquoring mother-liquid crystals to obtain the filter crystals.

3. The method according to claim 1, wherein the step of producing the filter crystals comprises: crushing a crystal to obtain the filter crystals.

4. The method according to claim 3, wherein the step of producing the filter crystals comprises: sieving the crushed crystals to obtain the filter crystals.

5. The method according to claim 1, wherein the step of providing the mixture, the material included in the mixture is immiscible and dispersed in the liquid.

6. A method for separating a mixture into a liquid and a material by using a melting filter medium, the method comprising the steps of:
producing a crystals by adding a liquid to a substance;
crushing the crystal to obtain filter crystals;
providing the mixture including the liquid to be passed and the material to be captured;
forming a crystal-filter layer of the filter crystals on a supporting wall having holes which supports the crystal-filter layer;
supplying the mixture to the crystal-filter layer to allow the liquid to pass through the crystal-filter layer and the holes of the supporting wall, while capturing the material by the crystal-filter layer;
separating from the supporting wall the crystal-filter layer that has captured the material; and
melting the filter crystals in the crystal-filter layer that has captured the material to allow the filter crystals and the captured material to separate.

7. The method according to claim 6, wherein the step of crushing the crystal comprises: sieving the crushed crystals to obtain the filter crystals.

8. The method according to claim 6, wherein the step of providing the mixture, the material included in the mixture is immiscible and dispersed in the liquid.

9. A system for separating a mixture into a liquid and a material by using a melting filter medium, the system comprising:
a crystal generator configured to produce filter crystals by cooling a mother liquid; a separator which has a crystal-filter layer of the filter crystals and a supporting wall having holes which supports thereon the crystal-filter layer, the separator being configured:
to receive on the crystal-filter layer the mixture including the liquid to be passed and the material to be captured,
to allow the liquid to pass through the crystal filter layer and the holes of the supporting wall, while capturing the material by the crystal-filter layer, and
to separate from the supporting wall the crystal-filter layer that has captured the material;
a liquid tank which receives the liquid from the separator; and
a melting device which receives from the separator the crystal-filter layer that has captured the material and which is configured to melt the crystal-filter layer to allow the crystal-filter layer and the captured material to separate.

10. The system according to claim 9, wherein the crystal generator includes a crushing device configured to crush a crystal to obtain the filter crystals.

11. The system according to claim 10, wherein the crushing device includes a sieving device configured to sieve the crushed crystals to obtain the filter crystals.

12. The system according to claim 9, wherein the material included in the mixture is immiscible and dispersed in the liquid.
